(19) United States
(12) Patent Application Publication
(10) Pub. No.: US 2025/0197702 A1
(43) Pub. Date: Jun. 19, 2025

(54) TWO-COMPONENT POLYURETHANE ADHESIVE COMPOSITION

(71) Applicant: DDP SPECIALTY ELECTRONIC MATERIALS US, LLC, Wilmington, DE (US)

(72) Inventors: Stefan SCHMATLOCH, FREIENBACH (CH); Gina-Gabriela BUMBU, FREIENBACH (CH); Ilona CADERAS, FREIENBACH (CH); Andreas LUTZ, FREIENBACH (CH)

(21) Appl. No.: 18/845,631

(22) PCT Filed: Apr. 5, 2023
(86) PCT No.: PCT/US2023/017518

§ 371 Date: Sep. 10, 2024

Related U.S. Application Data
(60) Provisional application No. 63/327,867, filed on Apr. 6, 2022.

(51) Int. Cl. C09J 175/08; C08G 18/12; C08K 3/04; C08K 3/22; C08K 7/18; C09J 9/00; C09J 11/04; C09K 5/14

(52) U.S. Cl. CPC C09J 175/08; C08G 18/12; C09J 9/00; C09J 11/04; C09K 5/14; C08K 3/04; C08K 2003/2227; C08K 7/18; C08K 2201/014; C08K 2201/016

(57) ABSTRACT

Provided herein is a two-component polyurethane adhesive composition.

### CROSS-REFERENCE TO RELATED APPLICATIONS

This application claims priority to U.S. Provisional Application No. 63/327,867, filed Apr. 6, 2022, which is incorporated into this application by reference.

### FIELD OF INVENTION

The present invention relates to the field of two-component polyurethane adhesive compositions.

### BACKGROUND OF THE INVENTION

The demand for affordable, higher autonomy range electrical vehicles has led to a rapid acceleration in innovation in electric vehicle (EV) battery concepts. Higher-energy-density, lighter, higher durability and more economical EV battery concepts have been developed during last decade.

The innovation efforts are primarily focused in two directions: 1. to extend the autonomy range by increasing the energy-packing density, and 2. to reduce the price of batteries. There are several strategies in the market to achieve a higher energy-density of the cell in order to save weight and increase the battery autonomy range, and all of them include a thermal management concept to optimize operation conditions and lifetime of the battery. Typical cells generate heat during standard operation conditions and charging. The optimal operating temperature of the cells lies between 25-40° C. The heat generated by the cells during operation is dissipated to a cooling plate. The cells or modules are connected to the cooling plate through a thermally-conductive material. In order to increase the mechanical stability of the battery a thermally conductive adhesive is needed.

One way to decrease the cost of the battery is to reduce its manufacturing cost e.g. production steps. To reduce the cost of an adhesive bond, reduction or elimination of steps for surface preparation for bonding is one approach. Another way to reduce the cost of the battery is to shorten the duration of the production steps.

The ideal requirements for thermally-conductive adhesives for battery applications are:
Thermal conductivity of 1 W/mK or greater;
An elongation at break of greater than 25% to enable the bonding of materials with different coefficients of thermal expansion;
Flame-resistance;
Low abrasiveness reducing maintenance of dispensing equipment;
Volume resistivity of 10¹⁰ Ωm or greater;
Good adhesion to multiple materials used in battery assemblies, such as bare aluminum, laser pretreated and nickel-plated steel.

Achieving a subset or all of these characteristics is difficult. A need remains for new and improved thermally-conductive adhesives.

### SUMMARY OF THE INVENTION

In a first aspect, the invention provides a two-component, thermally-conductive polyurethane adhesive comprising:
A. a first component (isocyanate) comprising an NCO-terminated prepolymer made by reacting at least one polyol with at least one polyisocyanate;
B. a second component (polyol) comprising an OH-terminated prepolymer made by reacting at least one polyol with at least one polyisocyanate, and a catalyst capable of catalyzing the reaction of isocyanate groups with OH groups;
   wherein Component A and/or Component B comprise the following fillers:
   aluminium trihydroxide having a multimodal particle size distribution;
   graphite having a spherical particle shape; and
   graphite having an aspect ratio greater than 2;
   such that when Component A and Component B are mixed together to form an adhesive mixture, the adhesive mixture comprises more than 40 wt % aluminium trihydroxide and more than 8 wt % graphite.

In a second aspect, the invention provides a kit for making an adhesive mixture, comprising:
A. a first component (isocyanate) comprising an NCO-terminated prepolymer made by reacting at least one polyol with at least one polyisocyanate;
B. a second component (polyol) comprising an OH-terminated prepolymer made by reacting at least one polyol with at least one polyisocyanate, and a catalyst capable of catalyzing the reaction of isocyanate groups with OH groups;
wherein Component A and/or Component B comprise the following fillers:
aluminium trihydroxide having a multimodal particle size distribution;
graphite having a spherical particle shape; and
graphite having an aspect ratio greater than 2;
such that when Component A and Component B are mixed together to form an adhesive mixture, the adhesive mixture comprises more than 40 wt % aluminium trihydroxide and more than 8 wt % graphite.

In a third aspect, the invention provides a method for adhering two or more substrates, the method comprising the steps:
(1) providing a two-component, thermally-conductive polyurethane adhesive comprising:
   A. a first component (isocyanate) comprising an NCO-terminated prepolymer made by reacting at least one polyol with at least one polyisocyanate;
   B. a second component (polyol) comprising an OH-terminated prepolymer made by reacting at least one polyol with at least one polyisocyanate and a catalyst capable of catalyzing the reaction of isocyanate groups with OH groups;
wherein Component A and/or Component B comprise the following fillers: aluminium trihydroxide having a multimodal particle size distribution;
graphite having a spherical particle shape; and
graphite having an aspect ratio greater than 2;
such that when Component A and Component B are mixed together to form an adhesive mixture, the adhesive mixture comprises more than 40 wt % aluminium trihydroxide and more than 8 wt % graphite;
(2) mixing the first component and the second component to obtain an adhesive mixture;
(3) applying the adhesive mixture to a first substrate;
(4) bringing the first substrate into adhesive contact with a second substrate; and
(5) allowing the adhesive mixture to cure.

In a fourth aspect, the invention provides an adhered assembly, comprising:
(1) a first substrate;
(2) a second substrate;
wherein the first substrate and the second substrate are adhered one to the other using a cured adhesive resulting from mixing and allowing to cure:
   A. a first component (isocyanate) comprising an NCO-terminated prepolymer made by reacting at least one polyol with at least one polyisocyanate; and
   B. a second component (polyol) comprising an OH-terminated prepolymer made by reacting at least one polyol with at least one polyisocyanate and a catalyst capable of catalyzing the reaction of isocyanate groups with OH groups;
wherein Component A and/or Component B comprise the following fillers: aluminium trihydroxide having a multimodal particle size distribution; graphite having a spherical particle shape; and graphite having an aspect ratio greater than 2;
such that when Component A and Component B are mixed together to form an adhesive mixture, the adhesive mixture comprises more than 40 wt % aluminium trihydroxide and more than 8 wt % graphite.

### DETAILED DESCRIPTION OF THE INVENTION

The inventors have found that it is possible to achieve good thermal conductivity, high bond strength on multiple substrates, low abrasiveness, flame-retardancy and reasonable elongation using the two-component polyurethane adhesive of the invention.

### Definitions and Abbreviations

MDI 4,4′-Methylenebis (phenyl isocyanate)
HDI Hexamethylene diisocyanate
IPDI isophorone diisocyanate
PU polyurethane
GPC gel permeation chromatography
RH relative humidity
ATH aluminium trihydroxide

Equivalent and molecular weights are measured by gel permeation chromatography (GPC) with a Malvern Viscothek GPC max equipment. Tetrahydrofuran (THF) was used as an eluent, PL GEL MIXED D (Agilent, 300*7.5 mm, 5 μm) was used as a column, and MALVERN Viscotek TDA (integrated refractive index viscometer and light scattering) was used as a detector.

Particle sizes of ATH were measured using laser diffraction with water containing 0.01 wt % sodium pyrophosphate as the suspending medium.

Particle sizes and aspect ratios for graphite were measured according to DIN 66165 part 1, with a 63-5000 μm sieve (according to DIN 4188).

### Component A (Isocyanate)

Component A comprises an NCO-terminated prepolymer made by reacting at least one polyol with at least one polyisocyanate.

The at least one polyol used to make the NCO-terminated prepolymer is preferably a polyether polyol.

The at least one polyol used to make the NCO-terminated prepolymer is preferably selected from polyols with functionality ≥2, more preferably 2-3, for example, diols, triols, and mixtures of these. Diols are particularly preferred.

Preferred polyether polyols used to make the NCO-terminated prepolymer include poly(C₂-C₄-alkylene oxide) polyols, in particular poly(ethylene oxide) polyols, poly(propylene oxide) polyols, poly(tetramethylene oxide) polyols, and mixtures of these, with poly(propylene oxide) polyols being particularly preferred.

In a preferred embodiment, the polyol used to make the NCO-terminated prepolymer is selected from poly(C₂-C₄-alkylene oxide) polyols, in particular poly(ethylene oxide) polyols having a functionality of 2-3, poly(propylene oxide) polyols having a functionality of 2-3, poly(tetramethylene oxide) polyols having a functionality of 2-3, and mixtures of these, with poly(propylene oxide) polyols having a functionality of 2-3 being particularly preferred.

The at least one polyol used to make the NCO-terminated prepolymer preferably has a molecular weight of from 400-2,500 Da.

The at least one polyol used to make the NCO-terminated prepolymer preferably has an average equivalent weight of 200-1,250 g/eq, more preferably 210-520 g/eq.

In a preferred embodiment, the at least one polyol used to make the NCO-terminated prepolymer is a mixture of polyols, in particular a mixture comprising a polyol having an average equivalent weight from 200-250 g/eq and a polyol having an average equivalent weight from 475-550 g/eq. In a particularly preferred embodiment, the at least one polyol used to make the NCO-terminated prepolymer is a mixture of a polyol having an equivalent weight of 200-220 g/eq and a polyol having an equivalent weight of 500-520 g/eq.

In a particularly preferred embodiment, the at least one polyol used to make the NCO-terminated prepolymer is a mixture of a poly(propylene oxide)-based polyol having an average equivalent weight from 200-250 g/eq and a poly(propylene oxide)-based polyol having an average equivalent weight from 475-550 g/eq. In a particularly preferred embodiment, the at least one polyol used to make the NCO-terminated prepolymer is a mixture of a poly(propylene oxide)-based polyol having an equivalent weight of 200-220 g/eq and a poly(propylene oxide)-based polyol having an equivalent weight of 500-520 g/eq.

In a particularly preferred embodiment, the at least one polyol used to make the NCO-terminated prepolymer is a mixture of a poly(propylene oxide)-based diol having an average equivalent weight from 200-250 g/eq and a poly(propylene oxide)-based diol having an average equivalent weight from 475-550 g/eq. In a particularly preferred embodiment, the at least one polyol used to make the NCO-terminated prepolymer is a mixture of a poly(propylene oxide)-based diol having an equivalent weight of 200-220 g/eq and a poly(propylene oxide)-based diol having an equivalent weight of 500-520 g/eq.

In a particularly preferred embodiment, the at least one polyol used to make the NCO-terminated prepolymer comprises a poly(propylene oxide)-based polyol having an average equivalent weight from 200-250 g/eq (P1) and a poly(propylene oxide)-based polyol having an average equivalent weight from 475-550 g/eq (P2), wherein the ratio of P1:P2 is 0.35-0.55, more preferably 0.43-0.47. In a particularly preferred embodiment, the at least one polyol used to make the NCO-terminated prepolymer is a mixture of a poly(propylene oxide)-based polyol having an equivalent weight of 200-220 g/eq (P1) and a poly(propylene oxide)-based polyol having an equivalent weight of 500-520 g/eq (P2), wherein the ratio of P1:P2 is 0.35-0.55, more preferably 0.43-0.47.

In a particularly preferred embodiment, the at least one polyol used to make the NCO-terminated prepolymer is a mixture of a poly(propylene oxide)-based diol having an average equivalent weight from 200-250 g/eq (P1) and a poly(propylene oxide)-based diol having an average equivalent weight from 475-550 g/eq (P2), wherein the ratio of P1:P2 is 0.35-0.55, more preferably 0.43-0.47. In a particularly preferred embodiment, the at least one polyol used to make the NCO-terminated prepolymer is a mixture of a poly(propylene oxide)-based diol having an equivalent weight of 200-220 g/eq (P1) and a poly(propylene oxide)-based diol having an equivalent weight of 500-520 g/eq (P2), wherein the ratio of P1:P2 is 0.35-0.55, more preferably 0.43-0.47.

In a preferred embodiment, the total polyol content in the NCO-terminated prepolymer is 9-20 wt %, more preferably 10-15 wt %, particularly preferably 12-14 wt %, based on the total weight of Component A.

In another preferred embodiment, Component A comprises a poly(propylene oxide) diol having an equivalent weight of 200-250 g/eq and a poly(propylene oxide)-based diol having an average equivalent weight from 475-550 g/eq.

In another preferred embodiment, Component A comprises 2-10 wt %, more preferably 3-6 wt %, more particularly preferably 4-5 wt % of a poly(propylene oxide) diol having an equivalent weight of 200-250 g/eq.

In another preferred embodiment, Component A comprises 6-15 wt %, more preferably 8-12 wt %, particularly preferably 9-10 wt % of a poly(propylene oxide)-based diol having an average equivalent weight from 475-550 g/eq.

In a particularly preferred embodiment, Component A comprises 2-10 wt %, more preferably 3-6 wt %, more particularly preferably 4-5 wt % of a poly(propylene oxide) diol having an equivalent weight of 200-250 g/eq, and

Component A comprises 6-15 wt %, more preferably 8-12 wt %, particularly preferably 9-10 wt % of a poly(propylene oxide)-based diol having an average equivalent weight from 475-550 g/eq.

In another particularly preferred embodiment, Component A comprises 2-10 wt %, more preferably 3-6 wt %, more particularly preferably 4-5 wt % of a poly(propylene oxide) diol having an equivalent weight of 200-250 g/eq (P1), and Component A comprises 6-15 wt %, more preferably 8-12 wt %, particularly preferably 9-10 wt % of a poly(propylene oxide)-based diol having an average equivalent weight from 475-550 g/eq (P2), and the ratio of P1:P2 is 0.35-0.55, more preferably 0.43-0.47.

The at least one polyisocyanate that is used to make the NCO-terminated prepolymer may be aliphatic or aromatic, with aromatic being preferred. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), with MDI being particularly preferred.

In a preferred embodiment, the polyisocyanate that is used to make the NCO-terminated prepolymer is MDI having a functionality of 2 or greater, in particular 2-3. Particularly preferably a mixture of MDI's is used, in particular a mixture of MDI having a functionality of 2-2.3 with an MDI having a functionality of 2.5-3, particularly a mixture of an MDI having a functionality of 2.2 with an MDI having a functionality of 2.7.

The total polyisocyanate content of Component A is preferably 20-40 wt %, more preferably 25-35 wt %, particularly preferably 28-32 wt %, based the total weight of Component A.

In a preferred embodiment, Component A comprises 25-35 wt %, more preferably 28-32 wt %, particularly preferably 30-31 wt % of MDI having a functionality of 2-2.3, particularly preferably 2.2, based on the total weight of Component A.

In another preferred embodiment, Component A comprises 0.25-1 wt %, more preferably 0.3-0.8 wt %, particularly preferably 0.5-0.7 wt % of MDI having a functionality of 2.5-3, particularly preferably 2.7, based on the total weight of Component A.

In a particularly preferred embodiment, Component A comprises 25-35 wt %, more preferably 28-32 wt %, particularly preferably 30-31 wt % of MDI having a functionality of 2-2.3, particularly preferably 2.2, based on the total weight of Component A, and 0.25-1 wt %, more preferably 0.3-0.8 wt %, particularly preferably 0.5-0.7 wt % of MDI having a functionality of 2.5-3, particularly preferably 2.7, based on the total weight of Component A.

The polyisocyanate is preferably used at 4:1 NCO equivalents to the OH groups in the polyols, so as to ensure that the prepolymer is NCO-terminated.

Some examples of the components of preferred NCO-terminated prepolymers are:
1. Polyol: 2-10 wt %, more preferably 3-6 wt %, more particularly preferably 4-5 wt % of a poly(propylene oxide) diol having an equivalent weight of 200-250 g/eq, and 6-15 wt %, more preferably 8-12 wt %, particularly preferably 9-10 wt % of a poly(propylene oxide)-based diol having an average equivalent weight from 475-550 g/eq, based on the total weight of Component A, and Isocyanate: 25-35 wt %, more preferably 28-32 wt %, particularly preferably 30-31 wt % of MDI having a functionality of 2-2.3, particularly preferably 2.2, based on the total weight of Component A, and 0.25-1 wt %, more preferably 0.3-0.8 wt %, particularly preferably 0.5-0.7 wt % of MDI having a functionality of 2.5-3, particularly preferably 2.7, based on the total weight of Component A;
2. Polyol: 4-5 wt % of a poly(propylene oxide) diol having an equivalent weight of 200-250 g/eq, and 9-10 wt % of a poly(propylene oxide)-based diol having an average equivalent weight from 475-550 g/eq, and
Isocyanate: 30-31 wt % of MDI having a functionality of 2-2.3, particularly preferably 2.2, based on the total weight of Component A, and 0.5-0.7 wt % of MDI having a functionality of 2.5-3, particularly preferably 2.7, based on the total weight of Component A.

Component A may additionally comprise an adhesion promoter, which is preferably a reactive silane.

Reactive silanes are any silanes that comprises a hydrolysable silyl alkoxy group covalently bonded to a mercapto group, a primary or secondary amine group, or an epoxy group.

In a particular preferred embodiment, the reactive silane is an epoxy silane. Preferably, the epoxy silane is selected from glycidyloxyalkyl(trialkoxy)silanes and glycidyloxyalkyl(methyl-dialkoxy)silanes. Examples of suitable epoxy silanes include Tris(diethylene glycol methylether) silyl propyleneglycidylether, (3-Glycidyloxypropyl)trimethoxysilane, (3-Glycidyloxypropyl)triethoxysilane, 3-Glycidoxypropylmethyldimethoxysilane, 3-Glycidoxypropylmethyldiethoxysilane, 2-(3,4-Epoxycyclohexyl)-ethyltrimethoxysilane, 2-(3,4-Epoxycyclohexyl)-ethyltriethoxysilane, with (3-Glycidyloxypropyl)trimethoxysilane being particularly preferred.

If used, the reactive silane is preferably present in Component A at 0.1-1 wt %, more preferably 0.25-0.75 wt %, particularly preferably 0.4-0.6 wt %, based on the total weight of Component A.

In a preferred embodiment, Component A comprises Glycidyloxypropyl)trimethoxysilane at 0.1-1 wt %, more preferably 0.25-0.75 wt %, particularly preferably 0.4-0.6 wt %, based on the total weight of Component A.

The NCO-terminated prepolymer of Component A is made by mixing the at least one polyol with the at least one polyisocyanate, preferably under vacuum, and at temperatures in the range of 60-80° C., more preferably 70-75° C.

The remaining ingredients of Component A, such as filler and adhesion promoter, if used, are added to the prepolymer and mixed to homogeneity, and Component A is then stored in a moisture-proof container.

### Component B (Polyol)

Component B comprises an OH-terminated prepolymer made by reacting at least one polyol with at least one polyisocyanate.

The at least one polyol used to make the OH-terminated prepolymer is preferably a polyether polyol.

The at least one polyol used to make the OH-terminated prepolymer is preferably selected from polyols with functionality ≥2, more preferably ≥3.

Preferred polyether polyols used to make the OH-terminated prepolymer include poly(C₂-C₄-alkylene oxide) polyols, in particular poly(ethylene oxide) polyols, poly(propylene oxide) polyols, poly(tetramethylene oxide) polyols, and mixtures of these, with poly(propylene oxide) polyols being particularly preferred.

In a preferred embodiment, the polyol used to make the OH-terminated prepolymer is selected from poly(C₂-C₄-alkylene oxide) polyols, in particular poly(ethylene oxide) polyols having a functionality of ≥3, poly(propylene oxide) polyols having a functionality of ≥3, poly(tetramethylene oxide) polyols having a functionality of ≥3, and mixtures of these, with poly(propylene oxide) polyols having a functionality of ≥3 being particularly preferred.

The at least one polyol used to make the OH-terminated prepolymer preferably has an average equivalent weight of 800-1,800 g/eq, more preferably 1,200-1,700 g/eq.

In a preferred embodiment, the at least one polyol used to make the OH-terminated prepolymer is a triol having an average equivalent weight of 800-1,800 g/eq, more preferably 1,200-1,700 g/eq.

In another preferred embodiment, the at least one polyol used to make the OH-terminated prepolymer is a poly(propylene oxide)-based triol having an average equivalent weight of 800-1,800 g/eq, more preferably 1,200-1,700 g/eq.

In a particularly preferred embodiment, the at least one polyol used to make the OH-terminated prepolymer is a poly(propylene oxide)-based triol having an average equivalent weight of 1,500-1,700 g/eq.

The at least one polyol is preferably used at 25-40 wt %, more preferably 27-35 wt %, particularly preferably 32-34 wt %, based on the total weight of Component B.

In a preferred embodiment, Component B comprises a poly(propylene oxide)-based triol having an average equivalent weight of 1,500-1,700 g/eq at 25-40 wt %, more preferably 27-35 wt %, particularly preferably 32-34 wt %, based on the total weight of Component B.

The at least one polyisocyanate that is used to make the OH-terminated prepolymer may be aliphatic or aromatic, with aromatic being preferred. Examples of suitable diisocyanates include toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), with MDI being particularly preferred.

In a preferred embodiment, the polyisocyanate that is used to make the OH-terminated prepolymer is MDI having a functionality of 2 or greater, in particular 2-3, particularly preferably a functionality of 2-2.3.

The total polyisocyanate content of Component B is preferably 0.25-2.5 wt %, more preferably 0.5-2 wt %, particularly preferably 1.2-1.6 wt %, based the total weight of Component B.

In a preferred embodiment, Component B comprises 0.25-2.5 wt %, more preferably 0.5-2 wt %, particularly preferably 1.2-1.6 wt %, based the total weight of Component B of MDI having a functionality of 2-2.3, particularly preferably 2.2.

The polyisocyanate is preferably used at 4:1 NCO equivalents to the OH groups in the polyols, so as to ensure that the prepolymer is OH-terminated.

Some examples of the components of preferred OH-terminated prepolymers are:
1. Polyol: 25-40 wt %, more preferably 27-35 wt %, particularly preferably 32-34 wt %, based on the total weight of Component B, of a poly(propylene oxide) triol having an equivalent weight of 1,500-1,700 g/eq, and Isocyanate: 0.25-2.5 wt %, more preferably 0.5-2 wt %, particularly preferably 1.2-1.6 wt %, based on the total weight of Component B, of MDI having a functionality of 2-2.3, particularly preferably 2.2;
2. Polyol: 32-34 wt %, based on the total weight of Component B, of a poly(propylene oxide) triol having an equivalent weight of 1,500-1,700 g/eq, and

Isocyanate: 1.2-1.6 wt %, based on the total weight of Component B, of MDI having a functionality of 2-2.3, particularly preferably 2.2;

Component B additionally comprises a catalyst that is capable of catalyzing the reaction of isocyanate groups with OH groups.

Examples of such catalysts include tertiary amine catalysts, organometallic catalysts, such as bismuth catalysts, alkyl tin carboxylates, oxides and tin mercaptides.

Specific examples of tertiary amine catalysts include N-methyl morpholine, N-methyl imidazole, triethylenediamine, bis-(2-dimethylaminoethyl)-ether, 1,4-diazabicyclo[2.2.2]octane (DABCO), dimethylcyclohexylamine, dimethylethanolamine, 2,2-dimorpholinyl-diethylether (DMDEE), N, N,N-dimethylaminopropyl hexahydrotriazine, dimethyltetrahydropyrimidine, tetramethylethylenediamine, dimethylcyclohexylamine, 2,2-N,N benzyldimethylamine, dimethylethanol amine, dimethylaminopropyl amine, Penta-dimethyl diethylene triamine, N,N,N′,N′-tetramethyl-1,6-hexanediamine, N,N′,N′-trimethylaminoethylpiperazine, 1,1′-[3-(dimethylamino) propyl]imino]bispropan-2-ol, 1,3,5-tris [3-(dimethylamino) propyl]hexahydro-1,3,5-triazine, N-N-dimethyldipropylene triamine, N,N,N′-trimethylaminoethylethanolamine, with DMDEE being particularly preferred.

If an organometallic catalyst is used, it is any organometallic catalyst capable of catalyzing the reaction of isocyanate with a functional group having at least one reactive hydrogen. Examples include bismuth catalysts, metal carboxylates such as tin carboxylate and zinc carboxylate. Metal alkanoates include stannous octoate, bismuth octoate or bismuth neodecanoate. Preferably the at least one organometallic catalyst is a bismuth catalyst or an organotin catalyst. Examples include dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate. In a preferred embodiment, the catalyst is a tin catalyst, particularly preferably dioctyltin mercaptide, and/or dimethyltin dithioglycolate. In a particularly preferred embodiment, the catalyst is a mixture of dioctyltin mercaptide, and dimethyltin dithioglycolate.

The catalyst is preferably used at 0.02 to 0.12 wt %, more preferably 0.03 to 0.1 wt %, based on the total weight of Component B.

In a preferred embodiment, the catalyst is dioctyl tin mercaptide, used at 0.03 to 0.07 wt % based on the total weight of Component B, and dimethyltin dithioglycolate, used at 0.001-0.003 wt %, based on the total weight of Component B.

Component B may additionally comprise an adhesion promoter, which is preferably a reactive silane.

Reactive silanes are any silanes that comprises a hydrolysable silyl alkoxy group covalently bonded to a mercapto group, a primary or secondary amine group, or an epoxy group.

In a particular preferred embodiment, the reactive silane is an epoxy silane. Preferably, the epoxy silane is selected from glycidyloxyalkyl(trialkoxy)silanes and glycidyloxyalkyl(methyl-dialkoxy)silanes. Examples of suitable epoxy silanes include Tris(diethylene glycol methylether) silyl propyleneglycidylether, (3-Glycidyloxypropyl)trimethoxysilane, (3-Glycidyloxypropyl)triethoxysilane, 3-Glycidoxypropylmethyldimethoxysilane, 3-Glycidoxypropylmethyldiethoxysilane, 2-(3,4-Epoxycyclohexyl)-ethyltrimethoxysilane, 2-(3,4-Epoxycyclohexyl)-ethyltriethoxysilane, with (3-Glycidyloxypropyl)trimethoxysilane being particularly preferred.

If used, the reactive silane is preferably present in Component B at 0.1-1 wt %, more preferably 0.25-0.75 wt %, particularly preferably 0.4-0.6 wt %, based on the total weight of Component B.

In a preferred embodiment, Component B comprises Glycidyloxypropyl)trimethoxysilane at 0.1-1 wt %, more preferably 0.25-0.75 wt %, particularly preferably 0.4-0.6 wt %, based on the total weight of Component B.

Component B may additionally comprise a diol or triol with molecular weight <200 Da, for example butane diol or glycerine, with butane diol being particularly preferred.

If used, the diol or triol with molecular weight <200 Da is preferably present at 3-9 wt %, more preferably 4-7 wt %, based on the total weight of Component B.

In a preferred embodiment, Component B comprises 1,4-butane diol at 3-9 wt %, more preferably 4-7 wt %, based on the total weight of Component B.

The OH-terminated prepolymer of Component B is made by mixing the at least one polyol with the at least one polyisocyanate, preferably under vacuum, and at temperatures in the range of 30-50° C., more preferably 32-40° C.

The remaining ingredients of Component B, such as filler, adhesion promoter, if used, and catalyst are added to the prepolymer and mixed to homogeneity, and Component B is then stored in a moisture-proof container.

### Filler

Component A and/or Component B comprise the following fillers:
aluminium trihydroxide having a multimodal particle size distribution;
graphite having a spherical particle shape; and
graphite having an aspect ratio greater than 2;
such that when Component A and Component B are mixed together to form an adhesive mixture, the adhesive mixture comprises more than 40 wt % aluminium trihydroxide and more than 8 wt % graphite.

The expression multimodal particle size distribution means that if the particle sizes are plotted with particle size on the x-axis and vol % on the y-axis, at least two main peaks are observed.

In a preferred embodiment, the aluminium trihydroxide is bimodal.

The particle size distribution of the aluminium trihydroxide is typically measured using laser diffraction, using water containing sodium pyrophosphate as a suspending agent.

In a preferred embodiment, the aluminium trihydroxide has the following particle size distribution:
1-20 vol %<1 μm, 10-30 vol % 1-10 μm, 5-30 vol. % 10-20 μm, >10 vol % 20-50 μm and >20 vol % 50-100 μm.

In a more preferred embodiment, the aluminium trihydroxide has the following particle size distribution:
1-10 vol %<1 μm, 5-20 vol % 1-10 μm, 6-20 vol % 10-20 μm, 5-40 vol % 20-50 μm and 35-60 vol % 50-100 μm.

In a more particularly preferred embodiment, the aluminium trihydroxide has the following particle size distribution:
1-5 vol %<1 μm, 5-15 vol % 1-10 μm, 6-15 vol % 10-20 μm, 20-40 vol % 20-50 μm and 40-70 vol % 50-100 μm.

Alternatively, the aluminium trihydroxide has the following particle size distribution:
1-20 wt %<1 μm, 5-30 wt % 1-10 μm, 3-30 wt % 10-20 μm, >10 wt % 20-50 μm, >35 wt % 50-100 μm.

More preferably, the aluminium trihydroxide has the following particle size distribution:
1-10 wt %<1 μm, 5-20 wt % 1-10 μm, 3-20 wt % 10-20 μm, 10-40 wt % 20-50 μm, 35-70 wt % 50-100 μm.

More particularly preferably, the aluminium trihydroxide has the following particle size distribution:
1-5 wt %<1 μm, 5-15 wt % 1-10 μm, 5-15 wt % 10-20 μm, 15-35 wt % 20-50 μm, 40-60 wt % 50-100 μm.

In a preferred embodiment, the aluminium trihydroxide comprises or consists of a mixture of:
aluminium trihydroxide having a D90 of 90-120 μm, more preferably a D₉₀ of 95-105 μm; and
aluminium trihydroxide having a D90 of 15-25 μm, more preferably 18-21 μm.

In another preferred embodiment, the aluminium trihydroxide comprises or consists of a mixture of:
aluminium trihydroxide having a D₉₀ of 95-105 μm; and
aluminium trihydroxide having a D₉₀ of 18-21 μm.

In another preferred embodiment, the aluminium trihydroxide comprises or consists of a mixture of:
aluminium trihydroxide having a D₉₀ of 90-120 μm, more preferably a D₉₀ of 95-105 μm, and a D₅₀ of 45-55 μm, more preferably a D₅₀ of 48-52 μm; and
aluminium trihydroxide having a D₉₀ of 15-25 μm, more preferably 18-21 μm, and a D₅₀ of 5-10 μm, more preferably a D₅₀ of 6-9 μm.

In another preferred embodiment, the aluminium trihydroxide comprises or consists of a mixture of:
aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
aluminium trihydroxide having a D₉₀ of 15-25 μm, more preferably 18-21 μm, and a D₅₀ of 5-10 μm, more preferably a D₅₀ of 6-9 μm.

In a preferred embodiment, the aluminium trihydroxide comprises or consists of a mixture of:
80-95 wt % aluminium trihydroxide having a D₉₀ of 90-120 μm, more preferably a D₉₀ of 95-105 μm; and
5-20 wt % aluminium trihydroxide having a D₉₀ of 15-25 μm, more preferably 18-21 μm;
based on the total amount of aluminium trihydroxide.

In another preferred embodiment, the aluminium trihydroxide comprises or consists of a mixture of:
80-95 wt % aluminium trihydroxide having a D₉₀ of 95-105 μm; and
5-20 wt % aluminium trihydroxide having a D₉₀ of 18-21 μm;
based on the total amount of aluminium trihydroxide.

In another preferred embodiment, the aluminium trihydroxide comprises or consists of a mixture of:
80-95 wt % aluminium trihydroxide having a D₉₀ of 90-120 μm, more preferably a D₉₀ of 95-105 μm, and a D₅₀ of 45-55 μm, more preferably a D₅₀ of 48-52 μm; and
5-20 wt % aluminium trihydroxide having a D₉₀ of 15-25 μm, more preferably 18-21 μm, and a D₅₀ of 5-10 μm, more preferably a D₅₀ of 6-9 μm;
based on the total amount of aluminium trihydroxide.

In another preferred embodiment, the aluminium trihydroxide comprises or consists of a mixture of:
80-95 wt % aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
5-20 wt % aluminium trihydroxide having a D₉₀ of 15-25 μm, more preferably 18-21 μm, and a D₅₀ of 5-10 μm, more preferably a D₅₀ of 6-9 μm;
based on the total amount of aluminium trihydroxide.

The ATH may be present in Component A, Component B or both. Preferably, both Component A and Component B comprise ATH.

In a preferred embodiment, Component A comprises ATH at 40-60 wt %, more preferably 45-55 wt % ATH, based on the total weight of Component A.

In a preferred embodiment, Component B comprises ATH at 40-60 wt %, more preferably 45-55 wt % ATH, based on the total weight of Component B.

In another preferred embodiment, Component A comprises ATH at 40-60 wt %, more preferably 45-55 wt % ATH, based on the total weight of

Component A, and Component B comprises ATH at 40-60 wt %, more preferably 45-55 wt % ATH, based on the total weight of Component B.

Component A and/or Component B comprise graphite having a spherical particle shape. For the purposes of this description, “spherical” means particles having an aspect ratio of 0.8-1.2, more preferably 0.9-1.1.

The spherical graphite preferably has a D₅₀ of 5-50 μm, more preferably 10-20 μm, particularly preferably 15-16.2 μm.

The spherical graphite preferably has a D₉₀ of 30-60 μm, more preferably 35-50 μm, particularly preferably 40-48 μm.

The spherical graphite preferably has a D₅₀ of 5-50 μm, more preferably 10-20 μm, particularly preferably 15-16.2 μm, and a D₉₀ of 30-60 μm, more preferably 35-50 μm, particularly preferably 40-48 μm.

The spherical graphite preferably has a BET surface area of 1-20 m²/g, more preferably 5-15 m²/g, particularly preferably 9 m²/g.

The spherical graphite preferably has a D₅₀ of 5-50 μm, more preferably 10-20 μm, particularly preferably 15-16.2 μm, and a BET surface area of 1-20 m²/g, more preferably 5-15 m²/g, particularly preferably 9 m²/g.

The spherical graphite preferably has a D₉₀ of 30-60 μm, more preferably 35-50 μm, particularly preferably 40-48 μm, and a BET surface area of 1-20 m²/g, more preferably 5-15 m²/g, particularly preferably 9 m²/g.

The spherical graphite preferably has a D₅₀ of 5-50 μm, more preferably 10-20 μm, particularly preferably 15-16.2 μm, and a D₉₀ of 30-60 μm, more preferably 35-50 μm, particularly preferably 40-48 μm, and a BET surface area of 1-20 m²/g, more preferably 5-15 m²/g, particularly preferably 9 m²/g.

The spherical graphite may be present in Component A, Component B or both. Preferably, both Component A and Component B comprise spherical graphite.

In a preferred embodiment, Component A comprises spherical graphite at 2-15 wt %, more preferably 4-8 wt %, based on the total weight of Component A.

In a preferred embodiment, Component B comprises spherical graphite at 5-20 wt %, more preferably 8-12 wt %, based on the total weight of Component B.

In another preferred embodiment, Component A comprises spherical graphite at 2-15 wt %, more preferably 4-8 wt %, based on the total weight of Component A, and Component B comprises spherical graphite at 5-20 wt %, more preferably 8-12 wt %, based on the total weight of Component B.

Component A and/or Component B comprise graphite having an aspect ratio greater than 2, more preferably greater than 3, particularly preferably greater than 4. The graphite having an aspect ratio of greater than 2 is preferably selected from graphite particles, graphene platelets and mixtures of these.

In a preferred embodiment, the graphite having an aspect ratio of greater than 2 is graphite particles having a D₉₀ of 80-110 μm, more preferably 85-95 μm.

In another preferred embodiment, the graphite having an aspect ratio of greater than 2 is graphene nanoplatelets, with a thickness of 10-30 nm, more preferably 16-20 nm, and an average particle size of 10-35 μm, more preferably 15-30 μm, particularly preferably 24-26 μm.

The graphite having an aspect ratio of >2 may be present in Component A, Component B or both. Preferably, both Component A and Component B comprise graphite having an aspect ratio of >2.

In a preferred embodiment, Component A comprises graphite having an aspect ratio of >2 at 0.5-2.5 wt %, more preferably 0.75-2 wt %, particularly preferably 0.0-1.3 wt %, based on the total weight of Component A.

In a preferred embodiment, Component B comprises graphite having an aspect ratio of >2 at 0.5-2.5 wt %, more preferably 0.75-2 wt %, particularly preferably 0.0-1.3 wt %, based on the total weight of Component B.

In another preferred embodiment, Component A comprises graphite having an aspect ratio of >2 at 0.5-2.5 wt %, more preferably 0.75-2 wt %, particularly preferably 0.0-1.3 wt %, based on the total weight of Component A, and Component B comprises graphite having an aspect ratio of >2 at 0.5-2.5 wt %, more preferably 0.75-2 wt %, particularly preferably 0.0-1.3 wt %, based on the total weight of Component B.

In a preferred embodiment, Component A and/or Component B comprise the following filler combinations:
1. ATH comprising or consisting of a mixture of:
   aluminium trihydroxide having a D₉₀ of 90-120 μm, more preferably a D₉₀ of 95-105 μm; and
   aluminium trihydroxide having a D₉₀ of 15-25 μm, more preferably 18-21 μm; AND
   Spherical graphite; AND
   Graphite having an aspect ratio of greater than 2.
2. ATH comprising or consisting of a mixture of:
   aluminium trihydroxide having a D₉₀ of 95-105 μm; and
   aluminium trihydroxide having a D₉₀ of 18-21 μm; AND
   Spherical graphite; AND
   Graphite having an aspect ratio of greater than 2.
3. ATH comprising or consisting of a mixture of:
   aluminium trihydroxide having a D₉₀ of 90-120 μm, more preferably a D₉₀ of 95-105 μm, and a D₅₀ of 45-55 μm, more preferably a D₅₀ of 48-52 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite; AND
   Graphite having an aspect ratio of greater than 2.
4. ATH comprising or consisting of a mixture of:
   aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite; AND
   Graphite having an aspect ratio of greater than 2.
5. ATH comprising or consisting of a mixture of:
   80-95 wt % aluminium trihydroxide having a D₉₀ of 90-120 μm, more preferably a D₉₀ of 95-105 μm; and
   5-20 wt % aluminium trihydroxide having a D₉₀ of 15-25 μm, more preferably 18-21 μm;
based on the total amount of aluminium trihydroxide; AND
   Spherical graphite; AND
   Graphite having an aspect ratio of greater than 2.
6. ATH comprising or consisting of a mixture of:
   80-95 wt % aluminium trihydroxide having a D₉₀ of 95-105 μm; and
   5-20 wt % aluminium trihydroxide having a D₉₀ of 18-21 μm; based on the total amount of aluminium trihydroxide; AND
   Spherical graphite; AND
   Graphite having an aspect ratio of greater than 2.
7. ATH comprising or consisting of a mixture of:
   80-95 wt % aluminium trihydroxide having a D₉₀ of 90-120 μm, more preferably a D₉₀ of 95-105 μm, and a D₅₀ of 45-55 μm, more preferably a D₅₀ of 48-52 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide; AND
   Spherical graphite; AND
   Graphite having an aspect ratio of greater than 2.
8. ATH comprising or consisting of a mixture of:
   80-95 wt % aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide; AND
   Spherical graphite; AND
   Graphite having an aspect ratio of greater than 2.
9. ATH comprising or consisting of a mixture of:
   aluminium trihydroxide having a D₉₀ of 90-120 μm, more preferably a D₉₀ of 95-105 μm; and
   aluminium trihydroxide having a D₉₀ of 15-25 μm, more preferably 18-21 μm; AND
   Spherical graphite having a D₅₀ of 5-50 μm, more preferably 10-20 μm, particularly preferably 15-16.2 μm; AND
   Graphite having an aspect ratio of greater than 2.
10. ATH comprising or consisting of a mixture of:
   aluminium trihydroxide having a D₉₀ of 95-105 μm; and
   aluminium trihydroxide having a D₉₀ of 18-21 μm; AND
   Spherical graphite having a D₅₀ of 5-50 μm, more preferably 10-20 μm, particularly preferably 15-16.2 μm; AND
   Graphite having an aspect ratio of greater than 2.
11. ATH comprising or consisting of a mixture of:
   aluminium trihydroxide having a D₉₀ of 90-120 μm, more preferably a D₉₀ of 95-105 μm, and a D₅₀ of 45-55 μm, more preferably a D₅₀ of 48-52 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite having a D₅₀ of 5-50 μm, more preferably 10-20 μm, particularly preferably 15-16.2 μm; AND
   Graphite having an aspect ratio of greater than 2.
12. ATH comprising or consisting of a mixture of:
   aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite having a D₅₀ of 5-50 μm, more preferably 10-20 μm, particularly preferably 15-16.2 μm; AND
   Graphite having an aspect ratio of greater than 2.
13. ATH comprising or consisting of a mixture of:
   80-95 wt % aluminium trihydroxide having a D₉₀ of 90-120 μm, more preferably a D₉₀ of 95-105 μm; and
   5-20 wt % aluminium trihydroxide having a D₉₀ of 15-25 μm, more preferably 18-21 μm;
   based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
14. ATH comprising or consisting of a mixture of:
   80-95 wt % aluminium trihydroxide having a D₉₀ of 95-105 μm; and
   5-20 wt % aluminium trihydroxide having a D₉₀ of 18-21 μm; based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
15. ATH comprising or consisting of a mixture of:
   80-95 wt % aluminium trihydroxide having a D₉₀ of 90-120 μm, more preferably a D₉₀ of 95-105 μm, and a D₅₀ of 45-55 μm, more preferably a D₅₀ of 48-52 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
16. ATH comprising or consisting of a mixture of:
   80-95 wt % aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
17. ATH having a bimodal particle size distribution; AND
   Spherical graphite; AND
   Graphite having an aspect ratio of greater than 2.
18. ATH having a bimodal particle size distribution; AND
   Spherical graphite having a D₅₀ of 5-50 μm, more preferably 10-20 μm, particularly preferably 15-16.2 μm; AND
   Graphite having an aspect ratio of greater than 2.
19. ATH having the following particle size distribution:
   1-20 vol %<1 μm, 10-30 vol % 1-10 μm, 5-30 vol. % 10-20 μm, >10 vol % 20-50 μm and >20 vol % 50-100 μm; AND
   Spherical graphite; AND
   Graphite having an aspect ratio of greater than 2.
20 ATH having the following particle size distribution: 1-20 vol %<1 μm, 10-30 vol % 1-10 μm, 5-30 vol. % 10-20 μm, >10 vol % 20-50 μm and >20 vol % 50-100 μm; AND
   Spherical graphite having a D₅₀ of 5-50 μm, more preferably 10-20 μm, particularly preferably 15-16.2 μm; AND
   Graphite having an aspect ratio of greater than 2.

The filler combination may be present in Component A, Component B or both. Preferably, both Component A and Component B comprise the filler combination.

In a preferred embodiment, Component A comprises total filler at 45-75 wt %, more preferably 50-60 wt % total filler, based on the total weight of Component A.

In a preferred embodiment, Component B comprises total filler at 45-75 wt %, more preferably 50-60 wt % total filler, based on the total weight of Component B.

In a preferred embodiment, Component A comprises total filler at 45-75 wt %, more preferably 50-60 wt % total filler, based on the total weight of Component A, and Component B comprises total filler at 45-75 wt %, more preferably 50-60 wt % total filler, based on the total weight of Component B.

### Method of Manufacture

The adhesive compositions of the invention are made by mixing the ingredients of each Component separately, preferably under inert and dry conditions and/or under vacuum, until a homogenous mixture is obtained. Once Component A and B are mixed, they are stored in separate containers until use.

### Method of Use

In one aspect, the invention provides a method for adhering two or more substrates, the method comprising the steps:
(1) providing a two-component, thermally-conductive polyurethane adhesive comprising:
   A. a first component (isocyanate) comprising an NCO-terminated prepolymer made by reacting at least one polyol with at least one polyisocyanate;
   B. a second component (polyol) comprising an OH-terminated prepolymer made by reacting at least one polyol with at least one polyisocyanate and a catalyst capable of catalyzing the reaction of isocyanate groups with OH groups;
wherein Component A and/or Component B comprise the following fillers: aluminium trihydroxide having the following particle size distribution 1-20 vol %<1 μm, 5-30 vol % 1-10 μm, 5-30 vol % 10-20 μm, >5 vol % 20-50 μm and >30 vol % 50-100 μm;
graphite having a spherical particle shape; and
graphite having an aspect ratio greater than 2;
such that when Component A and Component B are mixed together to form an adhesive mixture, the adhesive mixture comprises more than 40 wt % aluminium trihydroxide and more than 8 wt % graphite;
(2) mixing the first component and the second component to obtain an adhesive mixture;
(3) applying the adhesive mixture to a first substrate;
(4) bringing the first substrate into adhesive contact with a second substrate; and
(5) allowing the adhesive mixture to cure.

The ingredients for Components A and B, useful for the method of the invention, are as described for the adhesive.

Mixing is carried out by any method that can achieve a homogenous mixture fairly quickly. Typically, mixing is achieved by dispensing both components simultaneously into a mixing container or passage. Mixing of Component A and Component B may be in any desired proportion, but is typically done using a volumetric ratio A; B of 0.8-1.2, more preferably 1:1.

Applying the adhesive mixture to a substrate is typically manually (automatic) done using by using a suitable application gun and a static mixer. The adhesive is filled in cartridges which can ensure the suitable mixing ratio (in this case 1:1). The cartridges are placed in the application gun and a suitable static mixer is mounted. Then the adhesive is pressed through the static mixer on to the surface to be bond.

Curing is typically done at ambient temperature (e.g. 23° C.), and humidity (e.g. 50% relative humidity). Full cure with the adhesives of the invention usually develops in 7-10 days.

The substrates are not particularly limited, and include metals and plastics. The adhesives of the invention are particularly suited for adhering e-coated metals; acrylate coated surfaces; laser-treated metals (aluminum); nickel plated steel; plasma pretreated PET.

Preferred applications include thermal conductive material, used in any application where a thermal conductive material is needed, with main application in automotive industry for the thermal management of the EV battery; especially for the bonding of the modules or cell to cooling plate.

### Effect of the Invention

The cured adhesives of the invention (7 days, 23° C., 50% RH) preferably show a thermal conductivity of 1 W/mK or greater, more preferably 1.1 W/mK or greater, more particularly preferably 1.2 W/mK or greater. Thermal conductivity is measured according to ASTM 5470, as described in the Examples.

The cured adhesives of the invention (7 days, 23° C., 50% RH) preferably show an elongation at break of equal to or greater than 20%, more preferably greater than 23%. This enables the bonding of materials with different coefficients of thermal expansion. Elongation at break is measured according to ISO EN 572-2, material tested after full curing; 10 mm/min speed.

The cured adhesives of the invention (7 days, 23° C., 50% RH) preferably show a flame rating according to UL94 of V1 or better.

The cured adhesives of the invention (7 days, 23° C., 50% RH) preferably show a volume resistivity of 10¹⁰ Ωm or greater, more preferably 10¹¹ Ωm or greater, when measured according to DIN IEC 60093.

The adhesives of the invention show low abrasion, meaning that dispensing and mixing equipment need to be replaced less often.

### Particularly Preferred Embodiments

The following are particularly preferred embodiments of the adhesive compositions of the invention:
1. A two-component, thermally-conductive polyurethane adhesive comprising:
   A. a first component (isocyanate) comprising an NCO-terminated prepolymer made by reacting at least one polyol with at least one polyisocyanate;
   B. a second component (polyol) comprising an OH-terminated prepolymer made by reacting at least one polyol with at least one polyisocyanate, and a catalyst capable of catalyzing the reaction of isocyanate groups with OH groups;
   wherein Component A and/or Component B comprise the following fillers:
   aluminium trihydroxide having a multimodal (preferably bimodal) particle size distribution;
   graphite having a spherical particle shape; and
   graphite having an aspect ratio greater than 2;
   such that when Component A and Component B are mixed together to form an adhesive mixture, the adhesive mixture comprises more than 40 wt % aluminium trihydroxide and more than 8 wt % graphite.
2. A kit for making an adhesive mixture, comprising:
   A. a first component (isocyanate) comprising an NCO-terminated prepolymer made by reacting at least one polyol with at least one polyisocyanate;
   B. a second component (polyol) comprising an OH-terminated prepolymer made by reacting at least one polyol with at least one polyisocyanate, and a catalyst capable of catalyzing the reaction of isocyanate groups with OH groups;
   wherein Component A and/or Component B comprise the following fillers:
   aluminium trihydroxide having a multimodal (preferably bimodal) particle size distribution;
   graphite having a spherical particle shape; and
   graphite having an aspect ratio greater than 2;
   such that when Component A and Component B are mixed together to form an adhesive mixture, the adhesive mixture comprises more than 40 wt % aluminium trihydroxide and more than 8 wt % graphite.
3. A method for adhering two or more substrates, the method comprising the steps:
   (1) providing a two-component, thermally-conductive polyurethane adhesive comprising:
   A. a first component (isocyanate) comprising an NCO-terminated prepolymer made by reacting at least one polyol with at least one polyisocyanate;
   B. a second component (polyol) comprising an OH-terminated prepolymer made by reacting at least one polyol with at least one polyisocyanate and a catalyst capable of catalyzing the reaction of isocyanate groups with OH groups;
   wherein Component A and/or Component B comprise the following fillers:
   aluminium trihydroxide having a multimodal (preferably bimodal) particle size distribution;
   graphite having a spherical particle shape; and
   graphite having an aspect ratio greater than 2;
   such that when Component A and Component B are mixed together to form an adhesive mixture, the adhesive mixture comprises more than 40 wt % aluminium trihydroxide and more than 8 wt % graphite;
   (2) mixing the first component and the second component to obtain an adhesive mixture;
   (3) applying the adhesive mixture to a first substrate;
   (4) bringing the first substrate into adhesive contact with a second substrate; and
   (5) allowing the adhesive mixture to cure.
4. An adhered assembly, comprising:
   (1) a first substrate;
   (2) a second substrate;
   wherein the first substrate and the second substrate are adhered one to the other using a cured adhesive resulting from mixing and allowing to cure:
   A. a first component (isocyanate) comprising an NCO-terminated prepolymer made by reacting at least one polyol with at least one polyisocyanate; and
   B. a second component (polyol) comprising an OH-terminated prepolymer made by reacting at least one polyol with at least one polyisocyanate and a catalyst capable of catalyzing the reaction of isocyanate groups with OH groups;
   wherein Component A and/or Component B comprise the following fillers:
   aluminium trihydroxide having a multimodal (preferably bimodal) particle size distribution;
   graphite having a spherical particle shape; and
   graphite having an aspect ratio greater than 2;
   such that when Component A and Component B are mixed together to form an adhesive mixture, the adhesive mixture comprises more than 40 wt % aluminium trihydroxide and more than 8 wt % graphite.
5. Any one preceding embodiment, wherein the at least one polyol used to make the NCO-terminated prepolymer is a polyether polyol.
6. Any one preceding embodiment, wherein the at least one polyol used to make the NCO-terminated prepolymer is selected from polyols with functionality ≥2, more preferably 2-3.
7. Any one preceding embodiment, wherein the at least one polyol used to make the NCO-terminated prepolymer has a functionality of 2.
8. Any one preceding embodiment, wherein the polyol used to make the NCO-terminated prepolymer is selected from poly(C₂-C₄-alkylene oxide) polyols, in particular poly(ethylene oxide) polyols, poly(propylene oxide) polyols, poly(tetramethylene oxide) polyols, and mixtures of these.
9. Any one preceding embodiment, wherein the polyol used to make the NCO-terminated prepolymer a poly(propylene oxide) polyol.
10. Any one preceding embodiment, wherein the polyol used to make the NCO-terminated prepolymer is selected from poly(propylene oxide) polyols having a functionality of 2-3.
11. Any one preceding embodiment, wherein the at least one polyol used to make the NCO-terminated prepolymer has a molecular weight of from 400-2,500 Da.
12. Any one preceding embodiment, wherein the at least one polyol used to make the NCO-terminated prepolymer preferably has an average equivalent weight of 200-1,250 g/eq, more preferably 210-520 g/eq.
13. Any one preceding embodiment, wherein the at least one polyol used to make the NCO-terminated prepolymer is a mixture of polyols.
14. Any one preceding embodiment, wherein the at least one polyol used to make the NCO-terminated prepolymer is a mixture of polyols comprising a polyol having an average equivalent weight from 200-250 g/eq and a polyol having an average equivalent weight from 475-550 g/eq.
15. Any one preceding embodiment, wherein the at least one polyol used to make the NCO-terminated prepolymer is a mixture of a poly(propylene oxide)-based polyol having an average equivalent weight from 200-250 g/eq and a poly(propylene oxide)-based polyol having an average equivalent weight from 475-550 g/eq.
16. Any one preceding embodiment, wherein the at least one polyol used to make the NCO-terminated prepolymer is a mixture of a poly(propylene oxide)-based diol having an average equivalent weight from 200-250 g/eq and a poly(propylene oxide)-based diol having an average equivalent weight from 475-550 g/eq.
17. Any one preceding embodiment, wherein the at least one polyol used to make the NCO-terminated prepolymer comprises a poly(propylene oxide)-based polyol having an average equivalent weight from 200-250 g/eq (P1) and a poly(propylene oxide)-based polyol having an average equivalent weight from 475-550 g/eq (P2), wherein the ratio of P1:P2 is 0.35-0.55, more preferably 0.43-0.47.
18. Any one preceding embodiment, wherein the at least one polyol used to make the NCO-terminated prepolymer is a mixture of a poly(propylene oxide)-based diol having an average equivalent weight from 200-250 g/eq (P1) and a poly(propylene oxide)-based diol having an average equivalent weight from 475-550 g/eq (P2), wherein the ratio of P1:P2 is 0.35-0.55, more preferably 0.43-0.47.
19. Any one preceding embodiment, wherein the total polyol content in the NCO-terminated prepolymer is 9-20 wt %, more preferably 10-15 wt %, particularly preferably 12-14 wt %, based on the total weight of Component A.
20. Any one preceding embodiment, wherein Component A comprises 2-10 wt %, more preferably 3-6 wt %, more particularly preferably 4-5 wt % of a poly(propylene oxide) diol having an equivalent weight of 200-250 g/eq.
21. Any one preceding embodiment, wherein Component A comprises 6-15 wt %, more preferably 8-12 wt %, particularly preferably 9-10 wt % of a poly(propylene oxide)-based diol having an average equivalent weight from 475-550 g/eq.
22. Any one preceding embodiment, wherein Component A comprises 2-10 wt %, more preferably 3-6 wt %, more particularly preferably 4-5 wt % of a poly(propylene oxide) diol having an equivalent weight of 200-250 g/eq, and Component A comprises 6-15 wt %, more preferably 8-12 wt %, particularly preferably 9-10 wt % of a poly(propylene oxide)-based diol having an average equivalent weight from 475-550 g/eq.
23. Any one preceding embodiment, wherein Component A comprises 2-10 wt %, more preferably 3-6 wt %, more particularly preferably 4-5 wt % of a poly(propylene oxide) diol having an equivalent weight of 200-250 g/eq (P1), and Component A comprises 6-15 wt %, more preferably 8-12 wt %, particularly preferably 9-10 wt % of a poly(propylene oxide)-based diol having an average equivalent weight from 475-550 g/eq (P2), and the ratio of P1:P2 is 0.35-0.55, more preferably 0.43-0.47.
24. Any one preceding embodiment, wherein the at least one polyisocyanate that is used to make the NCO-terminated prepolymer is aromatic
25. Any one preceding embodiment, wherein the at least one polyisocyanate that is used to make the NCO-terminated prepolymer is selected from toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), and mixtures of these.
26. Any one preceding embodiment, wherein the at least one polyisocyanate that is used to make the NCO-terminated prepolymer is MDI.
27. Any one preceding embodiment, wherein the at least one polyisocyanate that is used to make the NCO-terminated prepolymer is MDI having a functionality of 2 or greater, in particular 2-3.
28. Any one preceding embodiment, wherein the at least one polyisocyanate that is used to make the NCO-terminated prepolymer is a mixture of MDI having a functionality of 2-2.3 with an MDI having a functionality of 2.5-3, particularly a mixture of an MDI having a functionality of 2.2 with an MDI having a functionality of 2.7.
29. Any one preceding embodiment, wherein the total polyisocyanate content of Component A is 20-40 wt %, more preferably 25-35 wt %, particularly preferably 28-32 wt %, based the total weight of Component A.
30. Any one preceding embodiment, wherein Component A comprises 25-35 wt %, more preferably 28-32 wt %, particularly preferably 30-31 wt % of MDI having a functionality of 2-2.3, particularly preferably 2.2, based on the total weight of Component A.
31. Any one preceding embodiment, wherein Component A comprises 0.25-1 wt %, more preferably 0.3-0.8 wt %, particularly preferably 0.5-0.7 wt % of MDI having a functionality of 2.5-3, particularly preferably 2.7, based on the total weight of Component A.
32. Any one preceding embodiment, wherein Component A comprises 25-35 wt %, more preferably 28-32 wt %, particularly preferably 30-31 wt % of MDI having a functionality of 2-2.3, particularly preferably 2.2, based on the total weight of Component A, and 0.25-1 wt %, more preferably 0.3-0.8 wt %, particularly preferably 0.5-0.7 wt % of MDI having a functionality of 2.5-3, particularly preferably 2.7, based on the total weight of Component A.
33. Any one preceding embodiment, wherein the polyisocyanate is used in Component A at 4:1 NCO equivalents to the OH groups in the polyols, so as to ensure that the prepolymer is NCO-terminated.
34. Any one preceding embodiment, wherein the components of the NCO-terminated prepolymers are:
   1. Polyol: 2-10 wt %, more preferably 3-6 wt %, more particularly preferably 4-5 wt % of a poly(propylene oxide) diol having an equivalent weight of 200-250 g/eq, and 6-15 wt %, more preferably 8-12 wt %, particularly preferably 9-10 wt % of a poly(propylene oxide)-based diol having an average equivalent weight from 475-550 g/eq, based on the total weight of Component A, and
   Isocyanate: 25-35 wt %, more preferably 28-32 wt %, particularly preferably 30-31 wt % of MDI having a functionality of 2-2.3, particularly preferably 2.2, based on the total weight of Component A, and 0.25-1 wt %, more preferably 0.3-0.8 wt %, particularly preferably 0.5-0.7 wt % of MDI having a functionality of 2.5-3, particularly preferably 2.7, based on the total weight of Component A; or
   2. Polyol: 4-5 wt % of a poly(propylene oxide) diol having an equivalent weight of 200-250 g/eq, and 9-10 wt % of a poly(propylene oxide)-based diol having an average equivalent weight from 475-550 g/eq, and
   Isocyanate: 30-31 wt % of MDI having a functionality of 2-2.3, particularly preferably 2.2, based on the total weight of Component A, and 0.5-0.7 wt % of MDI having a functionality of 2.5-3, particularly preferably 2.7, based on the total weight of Component A.
35. Any one preceding embodiment, wherein Component A comprises an adhesion promoter.
36. Any one preceding embodiment, wherein Component A comprises an adhesion promoter which is a reactive silane.
37. Any one preceding embodiment, wherein Component A comprises an adhesion promoter which is a silane that comprises a hydrolysable silyl alkoxy group covalently bonded to a mercapto group, a primary or secondary amine group, or an epoxy group.
38. Any one preceding embodiment, wherein Component A comprises an epoxy silane.
39. Embodiment 38, wherein the epoxy silane is selected from glycidyloxyalkyl(trialkoxy)silanes and glycidyloxyalkyl(methyl-dialkoxy)silanes.
40. Any one preceding embodiment, wherein Component A comprises (3-Glycidyloxypropyl)trimethoxysilane.
41. Any one preceding embodiment, wherein Component A comprises a reactive silane at 0.1-1 wt %, more preferably 0.25-0.75 wt %, particularly preferably 0.4-0.6 wt %, based on the total weight of Component A.
42. Any one preceding embodiment, wherein Component A comprises Glycidyloxypropyl)trimethoxysilane at 0.1-1 wt %, more preferably 0.25-0.75 wt %, particularly preferably 0.4-0.6 wt %, based on the total weight of Component A.
43. Any one preceding embodiment, wherein the at least one polyol used to make the OH-terminated prepolymer of Component B is a polyether polyol.
44. Any one preceding embodiment, wherein the at least one polyol used to make the OH-terminated prepolymer is selected from polyols with functionality ≥2, more preferably ≥3.
45. Any one preceding embodiment, wherein the polyol used to make the OH-terminated prepolymer is selected from poly(C₂-C₄-alkylene oxide) polyols, in particular poly(ethylene oxide) polyols, poly(propylene oxide) polyols, poly(tetramethylene oxide) polyols, and mixtures of these.
46. Any one preceding embodiment, wherein the polyol used to make the OH-terminated prepolymer is a poly(propylene oxide) polyol.
47. Any one preceding embodiment, wherein the polyol used to make the OH-terminated prepolymer is selected from poly(propylene oxide) polyols having a functionality of ≥3.
48. Any one preceding embodiment, wherein the at least one polyol used to make the OH-terminated prepolymer has an average equivalent weight of 800-1,800 g/eq, more preferably 1,200-1,700 g/eq.
49. Any one preceding embodiment, wherein the at least one polyol used to make the OH-terminated prepolymer is a triol having an average equivalent weight of 800-1,800 g/eq, more preferably 1,200-1,700 g/eq.
50. Any one preceding embodiment, wherein the at least one polyol used to make the OH-terminated prepolymer is a poly(propylene oxide)-based triol having an average equivalent weight of 800-1,800 g/eq, more preferably 1,200-1,700 g/eq.
51. Any one preceding embodiment, wherein the at least one polyol used to make the OH-terminated prepolymer is a poly(propylene oxide)-based triol having an average equivalent weight of 1,500-1,700 g/eq.
52. Any one preceding embodiment, wherein the at least one polyol used to make the OH-terminated prepolymer is used at 25-40 wt %, more preferably 27-35 wt %, particularly preferably 32-34 wt %, based on the total weight of Component B.
53. Any one preceding embodiment, wherein Component B comprises a poly(propylene oxide)-based triol having an average equivalent weight of 1,500-1,700 g/eq at 25-40 wt %, more preferably 27-35 wt %, particularly preferably 32-34 wt %, based on the total weight of Component B.
54. Any one preceding embodiment, wherein the at least one polyisocyanate that is used to make the OH-terminated prepolymer is aromatic.
55. Any one preceding embodiment, wherein the at least one polyisocyanate that is used to make the OH-terminated prepolymer is selected from toluene diisocyanate (TDI), hexamethylene diisocyanate (HDI), naphthalene diisocyanate (NDI), methylene bis-cyclohexylisocyanate (HMDI) (hydrogenated MDI), MDI (in particular 4,4′- and 4,2-MDI) and isophorone diisocyanate (IPDI), and mixtures of these.
56. Any one preceding embodiment, wherein the at least one polyisocyanate that is used to make the OH-terminated prepolymer is MDI.
57. Any one preceding embodiment, wherein the at least one polyisocyanate that is used to make the OH-terminated prepolymer is MDI having a functionality of 2 or greater, in particular 2-3, particularly preferably a functionality of 2-2.3.
58. Any one preceding embodiment, wherein the total polyisocyanate content of Component B is 0.25-2.5 wt %, more preferably 0.5-2 wt %, particularly preferably 1.2-1.6 wt %, based the total weight of Component B.
59. Any one preceding embodiment, wherein Component B comprises 0.25-2.5 wt %, more preferably 0.5-2 wt %, particularly preferably 1.2-1.6 wt %, based the total weight of Component B of MDI having a functionality of 2-2.3, particularly preferably 2.2.
60. Any one preceding embodiment, wherein the polyisocyanate is used in Component B at 1:10 NCO equivalents to the OH groups in the polyols, so as to ensure that the prepolymer is OH-terminated.
61. Any one preceding embodiment, wherein the OH-terminated prepolymer is made from the following ingredients:
   1. Polyol: 25-40 wt %, more preferably 27-35 wt %, particularly preferably 32-34 wt %, based on the total weight of Component B, of a poly(propylene oxide) triol having an equivalent weight of 1,500-1,700 g/eq, and
   Isocyanate: 0.25-2.5 wt %, more preferably 0.5-2 wt %, particularly preferably 1.2-1.6 wt %, based on the total weight of Component B, of MDI having a functionality of 2-2.3, particularly preferably 2.2; or 2. Polyol: 32-34 wt %, based on the total weight of Component B, of a poly(propylene oxide) triol having an equivalent weight of 1,500-1,700 g/eq, and
   Isocyanate: 1.2-1.6 wt %, based on the total weight of Component B, of MDI having a functionality of 2-2.3, particularly preferably 2.2.
62. Any one preceding embodiment, wherein the catalyst is selected from tertiary amine catalysts, organometallic catalysts, and mixtures of these.
63. Any one preceding embodiment, wherein the catalyst is selected from N-methyl morpholine, N-methyl imidazole, triethylenediamine, bis-(2-dimethylaminoethyl)-ether, 1,4-diazabicyclo[2.2.2]octane (DABCO), dimethylcyclohexylamine, dimethylethanolamine, 2,2-dimorpholinyl-diethylether (DMDEE), N,N,N-dimethylaminopropyl hexahydrotriazine, dimethyltetrahydropyrimidine, tetramethylethylenediamine, dimethylcyclohexylamine, 2,2-N,N benzyldimethylamine, dimethylethanol amine, dimethylaminopropyl amine, Penta-dimethyl diethylene triamine, N,N,N′, N′-tetramethyl-1,6-hexanediamine, N,N′, N′-trimethylaminoethylpiperazine, 1,1′-[[3-(dimethylamino) propyl] imino] bispropan-2-ol, 1,3,5-tris [3-(dimethylamino) propyl] hexahydro-1,3,5-triazine, N-N-dimethyldipropylene triamine, N,N,N′-trimethylaminoethylethanolamine, and mixtures of these.
64. Any one preceding embodiment, wherein the catalyst is selected from organotin catalysts.
65. Any one preceding embodiment, wherein the catalyst is selected from dibutyltin dilaurate, dimethyl tin dineodecanoate, dimethyltin mercaptide, dimethyltin carboxylate, dimethyltin dioleate, dimethyltin dithioglycolate, dibutyltin mercaptide, dibutyltin bis(2-ethylhexyl thioglycolate), dibutyltin sulfide, dioctyltin dithioglycolate, dioctyltin mercaptide, dioctyltin dioctoate, dioctyltin dineodecanoate, dioctyltin dilaurate., and mixtures of these.
66. Any one preceding embodiment, wherein the catalyst is selected from dioctyltin mercaptide, dimethyltin dithioglycolate, and mixtures of these.
67. Any one preceding embodiment, wherein the catalyst is used at 0.02 to 0.12 wt %, more preferably 0.03 to 0.1 wt %, based on the total weight of Component B.
68. Any one preceding embodiment, wherein the catalyst is dioctyl tin mercaptide, used at 0.03 to 0.07 wt % based on the total weight of Component B, and dimethyltin dithioglycolate, used at 0.001-0.003 wt %, based on the total weight of Component B.
69. Any one preceding embodiment, wherein Component B comprises an adhesion promoter.
70. Any one preceding embodiment, wherein Component B comprises a reactive silane.
71. Embodiment 70, wherein the reactive silane is a hydrolysable silyl alkoxy group covalently bonded to a mercapto group, a primary or secondary amine group, or an epoxy group.
72. Any one preceding embodiment, wherein Component B comprises an epoxy silane.
73. Embodiment 72, wherein the epoxy silane is selected from glycidyloxyalkyl(trialkoxy)silanes and glycidyloxyalkyl(methyl-dialkoxy)silanes.
74. Embodiment 72, wherein the epoxy silane is selected from Tris(diethylene glycol methylether) silyl propyleneglycidylether, (3-Glycidyloxypropyl)trimethoxysilane, (3-Glycidyloxypropyl)triethoxysilane, 3-Glycidoxypropylmethyldimethoxysilane, 3-Glycidoxypropylmethyldiethoxysilane, 2-(3,4-Epoxycyclohexyl)-ethyltrimethoxysilane, 2-(3,4-Epoxycyclohexyl)-ethyltriethoxysilane, and mixtures of these.
75. Any one preceding embodiment, wherein Component B comprises (3-Glycidyloxypropyl)trimethoxysilane.
76. Any one preceding embodiment, wherein Component B comprises a reactive silane at 0.1-1 wt %, more preferably 0.25-0.75 wt %, particularly preferably 0.4-0.6 wt %, based on the total weight of Component B.
77. Any one preceding embodiment, wherein Component B comprises Glycidyloxypropyl)trimethoxysilane at 0.1-1 wt %, more preferably 0.25-0.75 wt %, particularly preferably 0.4-0.6 wt %, based on the total weight of Component B.
78. Any one preceding embodiment, wherein the aluminium trihydroxide has a bimodal particle size distribution.
79. Any one preceding embodiment, wherein the aluminium trihydroxide comprises or consists of a mixture of:
   aluminium trihydroxide having a D₉₀ of 90-120 μm, more preferably a D₉₀ of 95-105 μm; and
   aluminium trihydroxide having a D₉₀ of 15-25 μm, more preferably 18-21 μm.
80. Any one preceding embodiment, wherein the aluminium trihydroxide has the following particle size distribution:
   1-20 wt %<1 μm, 5-30 wt % 1-10 μm, 3-30 wt % 10-20 μm, >10 wt % 20-50 μm, >35 wt % 50-100 μm.
81. Any one preceding embodiment, wherein the aluminium trihydroxide has the following particle size distribution:
   1-10 wt %<1 μm, 5-20 wt % 1-10 μm, 3-20 wt % 10-20 μm, 10-40 wt % 20-50 μm, 35-70 wt % 50-100 μm.
82. Any one preceding embodiment, wherein the aluminium trihydroxide has the following particle size distribution:
   1-5 wt %<1 μm, 5-15 wt % 1-10 μm, 5-15 wt % 10-20 μm, 15-35 wt % 20-50 μm, 40-60 wt % 50-100 μm.
83. Any one preceding embodiment, wherein the aluminium trihydroxide comprises or consists of a mixture of:
   aluminium trihydroxide having a D₉₀ of 95-105 μm; and
   aluminium trihydroxide having a D₉₀ of 18-21 μm.
84. Any one preceding embodiment, wherein the aluminium trihydroxide comprises or consists of a mixture of:
   aluminium trihydroxide having a D₉₀ of 90-120 μm, more preferably a D₉₀ of 95-105 μm, and a D₅₀ of 45-55 μm, more preferably a D₅₀ of 48-52 μm; and
   aluminium trihydroxide having a D₉₀ of 15-25 μm, more preferably 18-21 μm, and a D₅₀ of 5-10 μm, more preferably a D₅₀ of 6-9 μm.
85. Any one preceding embodiment, wherein the aluminium trihydroxide comprises or consists of a mixture of:
   aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   aluminium trihydroxide having a D₉₀ of 15-25 μm, more preferably 18-21 μm, and a D₅₀ of 5-10 μm, more preferably a D₅₀ of 6-9 μm.
86. Any one preceding embodiment, wherein the aluminium trihydroxide comprises or consists of a mixture of:
   80-95 wt % aluminium trihydroxide having a D₉₀ of 90-120 μm, more preferably a D₉₀ of 95-105 μm; and
   5-20 wt % aluminium trihydroxide having a D₉₀ of 15-25 μm, more preferably 18-21 μm;
   based on the total amount of aluminium trihydroxide.
87. Any one preceding embodiment, wherein the aluminium trihydroxide comprises or consists of a mixture of:
   80-95 wt % aluminium trihydroxide having a D₉₀ of 95-105 μm; and
   5-20 wt % aluminium trihydroxide having a D₉₀ of 18-21 μm; based on the total amount of aluminium trihydroxide.
88. Any one preceding embodiment, wherein the aluminium trihydroxide comprises or consists of a mixture of:
   80-95 wt % aluminium trihydroxide having a D₉₀ of 90-120 μm, more preferably a D₉₀ of 95-105 μm, and a D₅₀ of 45-55 μm, more preferably a D₅₀ of 48-52 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide.
89. Any one preceding embodiment, wherein the aluminium trihydroxide comprises or consists of a mixture of:
   80-95 wt % aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide.
90 Any one preceding embodiment, wherein the ATH is present in Component A, Component B or both.
91. Any one preceding embodiment, wherein both Component A and Component B comprise ATH.
92. Any one preceding embodiment, wherein Component A comprises ATH at 40-60 wt %, more preferably 45-55 wt % ATH, based on the total weight of Component A.
93. Any one preceding embodiment, wherein Component B comprises ATH at 40-60 wt %, more preferably 45-55 wt % ATH, based on the total weight of Component B.
94. Any one preceding embodiment, wherein Component A comprises ATH at 40-60 wt %, more preferably 45-55 wt % ATH, based on the total weight of Component A, and Component B comprises ATH at 40-60 wt %, more preferably 45-55 wt % ATH, based on the total weight of Component B.
95. Any one preceding embodiment, wherein Component A and/or Component B comprise graphite having an aspect ratio of 0.8-1.2, more preferably 0.9-1.1.
96. Any one preceding embodiment, wherein the spherical graphite has a D₅₀ of 5-50 μm, more preferably 10-20 μm, particularly preferably 15-16.2 μm.
97. Any one preceding embodiment, wherein the spherical graphite has a D₉₀ of 30-60 μm, more preferably 35-50 μm, particularly preferably 40-48 μm.
98 Any one preceding embodiment, wherein the spherical graphite has a D₅₀ of 5-50 μm, more preferably 10-20 μm, particularly preferably 15-16.2 μm, and a D₉₀ of 30-60 μm, more preferably 35-50 μm, particularly preferably 40-48 μm.
99. Any one preceding embodiment, wherein the spherical graphite has a BET surface area of 1-20 m²/g, more preferably 5-15 m²/g, particularly preferably 9 m²/g.
100. Any one preceding embodiment, wherein the spherical graphite has a D₅₀ of 5-50 μm, more preferably 10-20 μm, particularly preferably 15-16.2 μm, and a BET surface area of 1-20 m²/g, more preferably 5-15 m²/g, particularly preferably 9 m²/g.
101. Any one preceding embodiment, wherein the spherical graphite has a D₉₀ of 30-60 μm, more preferably 35-50 μm, particularly preferably 40-48 μm, and a BET surface area of 1-20 m²/g, more preferably 5-15 m²/g, particularly preferably 9 m²/g.
102. Any one preceding embodiment, wherein the spherical graphite has a D₅₀ of 5-50 μm, more preferably 10-20 μm, particularly preferably 15-16.2 μm, and a D₉₀ of 30-60 μm, more preferably 35-50 μm, particularly preferably 40-48 μm, and a BET surface area of 1-20 m²/g, more preferably 5-15 m²/g, particularly preferably 9 m²/g.
103. Any one preceding embodiment, wherein the spherical graphite is present in Component A, Component B or both.
104. Any one preceding embodiment, wherein both Component A and Component B comprise spherical graphite.
105. Any one preceding embodiment, wherein Component A comprises spherical graphite at 2-15 wt %, more preferably 4-8 wt %, based on the total weight of Component A.
106. Any one preceding embodiment, wherein Component B comprises spherical graphite at 5-20 wt %, more preferably 8-12 wt %, based on the total weight of Component B.
107. Any one preceding embodiment, wherein Component A comprises spherical graphite at 2-15 wt %, more preferably 4-8 wt %, based on the total weight of Component A, and Component B comprises spherical graphite at 5-20 wt %, more preferably 8-12 wt %, based on the total weight of Component B.
108. Any one preceding embodiment, wherein the graphite having an aspect ratio of greater than 2 has an aspect ratio of greater than 3.
109. Any one preceding embodiment, wherein the graphite having an aspect ratio of greater than 2 has an aspect ratio of greater than 4.
110. Any one preceding embodiment, wherein the graphite having an aspect ratio of greater than 2 is selected from graphite particles, graphene platelets and mixtures of these.
111. Any one preceding embodiment, wherein the graphite having an aspect ratio of greater than 2 is graphite particles having a D₉₀ of 80-110 μm, more preferably 85-95 μm.
112. Any one preceding embodiment, wherein the graphite having an aspect ratio of greater than 2 is graphene nanoplatelets, with a thickness of 10-30 nm, preferably 16-20 nm, and an average particle size of 10-35 μm, more preferably 15-30 μm, particularly preferably 24-26 μm.
113. Any one preceding embodiment, wherein the graphite having an aspect ratio of >2 is present in Component A, Component B or both.
114. Any one preceding embodiment, wherein both Component A and Component B comprise graphite having an aspect ratio of >2.
115. Any one preceding embodiment, wherein Component A comprises graphite having an aspect ratio of >2 at 0.5-2.5 wt %, more preferably 0.75-2 wt %, particularly preferably 0.0-1.3 wt %, based on the total weight of Component A.
116. Any one preceding embodiment, wherein Component B comprises graphite having an aspect ratio of >2 at 0.5-2.5 wt %, more preferably 0.75-2 wt %, particularly preferably 0.0-1.3 wt %, based on the total weight of Component B.
117. Any one preceding embodiment, wherein Component A comprises graphite having an aspect ratio of >2 at 0.5-2.5 wt %, more preferably 0.75-2 wt %, particularly preferably 0.0-1.3 wt %, based on the total weight of Component A, and Component B comprises graphite having an aspect ratio of >2 at 0.5-2.5 wt %, more preferably 0.75-2 wt %, particularly preferably 0.0-1.3 wt %, based on the total weight of Component B.
118. Any one preceding embodiment, wherein Component A and/or Component B comprise the following filler combinations:
   1. ATH comprising or consisting of a mixture of:
   aluminium trihydroxide having a D₉₀ of 90-120 μm, more preferably a D₉₀ of 95-105 μm; and
   aluminium trihydroxide having a D₉₀ of 15-25 μm, more preferably 18-21 μm; AND
   Spherical graphite; AND
   Graphite having an aspect ratio of greater than 2.
   2. ATH comprising or consisting of a mixture of:
   aluminium trihydroxide having a D₉₀ of 95-105 μm; and
   aluminium trihydroxide having a D₉₀ of 18-21 μm; AND
   Spherical graphite; AND
   Graphite having an aspect ratio of greater than 2.
   3. ATH comprising or consisting of a mixture of:
   aluminium trihydroxide having a D₉₀ of 90-120 μm, more preferably a D₉₀ of 95-105 μm, and a D₅₀ of 45-55 μm, more preferably a D₅₀ of 48-52 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite; AND
   Graphite having an aspect ratio of greater than 2.
   4. ATH comprising or consisting of a mixture of:
   aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite; AND
   Graphite having an aspect ratio of greater than 2.
   5. ATH comprising or consisting of a mixture of:
   80-95 wt % aluminium trihydroxide having a D₉₀ of 90-120 μm, more preferably a D₉₀ of 95-105 μm; and
   5-20 wt % aluminium trihydroxide having a D₉₀ of 15-25 μm, more preferably 18-21 μm;
   based on the total amount of aluminium trihydroxide; AND
   Spherical graphite; AND
   Graphite having an aspect ratio of greater than 2.
6. ATH comprising or consisting of a mixture of:
   80-95 wt % aluminium trihydroxide having a D₉₀ of 95-105 μm; and
   5-20 wt % aluminium trihydroxide having a D₉₀ of 18-21 μm; based on the total amount of aluminium trihydroxide; AND
   Spherical graphite; AND
   Graphite having an aspect ratio of greater than 2.
   7. ATH comprising or consisting of a mixture of:
   80-95 wt % aluminium trihydroxide having a D₉₀ of 90-120 μm, more preferably a D₉₀ of 95-105 μm, and a D₅₀ of 45-55 μm, more preferably a D₅₀ of 48-52 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide; AND
   Spherical graphite; AND
   Graphite having an aspect ratio of greater than 2.
   8. ATH comprising or consisting of a mixture of:
   80-95 wt % aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide; AND
   Spherical graphite; AND
   Graphite having an aspect ratio of greater than 2.
   9. ATH comprising or consisting of a mixture of:
   aluminium trihydroxide having a D₉₀ of 90-120 μm, more preferably a D₉₀ of 95-105 μm; and
   aluminium trihydroxide having a D₉₀ of 15-25 μm, more preferably 18-21 μm; AND
   Spherical graphite having a D₅₀ of 5-50 μm, more preferably 10-20 μm, particularly preferably 15-16.2 μm; AND
   Graphite having an aspect ratio of greater than 2.
   10. ATH comprising or consisting of a mixture of:
   aluminium trihydroxide having a D₉₀ of 95-105 μm; and
   aluminium trihydroxide having a D₉₀ of 18-21 μm; AND
   Spherical graphite having a D₅₀ of 5-50 μm, more preferably 10-20 μm, particularly preferably 15-16.2 μm; AND
   Graphite having an aspect ratio of greater than 2. 11. ATH comprising or consisting of a mixture of:
   aluminium trihydroxide having a D₉₀ of 90-120 μm, more preferably a D₉₀ of 95-105 μm, and a D₅₀ of 45-55 μm, more preferably a D₅₀ of 48-52 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite having a D₅₀ of 5-50 μm, more preferably 10-20 μm, particularly preferably 15-16.2 μm; AND
   Graphite having an aspect ratio of greater than 2.
   12. ATH comprising or consisting of a mixture of:
   aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   aluminium trihydroxide having a D₉₀ of 15-25 μm, more preferably 18-21 μm, and a D₅₀ of 5-10 μm, more preferably a D₅₀ of 6-9 μm; AND
   Spherical graphite having a D₅₀ of 5-50 μm, more preferably 10-20 μm, particularly preferably 15-16.2 μm; AND
   Graphite having an aspect ratio of greater than 2.
   13. ATH comprising or consisting of a mixture of:
   80-95 wt % aluminium trihydroxide having a D₉₀ of 90-120 μm, more preferably a D₉₀ of 95-105 μm; and
   5-20 wt % aluminium trihydroxide having a D₉₀ of 15-25 μm, more preferably 18-21 μm;
   based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
   14. ATH comprising or consisting of a mixture of:
   80-95 wt % aluminium trihydroxide having a D₉₀ of 95-105 μm; and
   5-20 wt % aluminium trihydroxide having a D₉₀ of 18-21 μm; based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
   15. ATH comprising or consisting of a mixture of:
   80-95 wt % aluminium trihydroxide having a D₉₀ of 90-120 μm, more preferably a D₉₀ of 95-105 μm, and a D₅₀ of 45-55 μm, more preferably a D₅₀ of 48-52 μm; and
   5-20 wt % aluminium trihydroxide having a Doo of 15-25 μm, more preferably 18-21 μm, and a D₅₀ of 5-10 μm, more preferably a D₅₀ of 6-9 μm;
   based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
   16. ATH comprising or consisting of a mixture of:
   80-95 wt % aluminium trihydroxide having a D₉₀ of 90-120 μm, more preferably a D₉₀ of 95-105 μm, a D₅₀ of 45-55 μm, more preferably a D₅₀ of 48-52 μm, and a D₁₀ of 8-12 μm, more preferably 9-11 μm; and
   5-20 wt % aluminium trihydroxide having a D₉₀ of 15-25 μm, more preferably 18-21 μm, and a D₅₀ of 5-10 μm, more preferably a D₅₀ of 6-9 μm;
   based on the total amount of aluminium trihydroxide; AND
   Spherical graphite having a D₅₀ of 5-50 μm, more preferably 10-20 μm, particularly preferably 15-16.2 μm; AND
   Graphite having an aspect ratio of greater than 2.
   17. ATH having a bimodal particle size distribution; AND
   Spherical graphite; AND
   Graphite having an aspect ratio of greater than 2.
   18. ATH having a bimodal particle size distribution; AND
   Spherical graphite having a D₅₀ of 5-50 μm, more preferably 10-20 μm, particularly preferably 15-16.2 μm; AND
   Graphite having an aspect ratio of greater than 2.
   19. ATH having the following particle size distribution:
   1-20 vol %<1 μm, 10-30 vol % 1-10 μm, 5-30 vol. % 10-20 μm, >10 vol % 20-50 μm and >20 vol % 50-100 μm; AND
   Spherical graphite; AND
   Graphite having an aspect ratio of greater than 2.
   20. ATH having the following particle size distribution: 1-20 vol %<1 μm, 10-30 vol % 1-10 μm, 5-30 vol. % 10-20 μm, >10 vol % 20-50 μm and >20 vol % 50-100 μm; AND
   Spherical graphite having a D₅₀ of 5-50 μm, more preferably 10-20 μm, particularly preferably 15-16.2 μm; AND
   Graphite having an aspect ratio of greater than 2.
119. Any one preceding embodiment, wherein the filler combination is present in Component A, Component B or both. Preferably, both Component A and Component B comprise the filler combination.
120. Any one preceding embodiment, wherein Component A comprises total filler at 45-75 wt %, more preferably 50-60 wt % total filler, based on the total weight of Component A.
121. Any one preceding embodiment, wherein Component B comprises total filler at 45-75 wt %, more preferably 50-60 wt % total filler, based on the total weight of Component B.
122. Any one preceding embodiment, wherein Component A comprises total filler at 45-75 wt %, more preferably 50-60 wt % total filler, based on the total weight of Component A, and Component B comprises total filler at 45-75 wt %, more preferably 50-60 wt % total filler, based on the total weight of Component B.
123. Any one preceding embodiment, wherein Component A and Component B are mixed in a volumetric ratio A:B of 0.8-1.2, more preferably 1:1.
124. Any one preceding embodiment, wherein Component B comprises a diol or triol having molecular weight of less than 200 Da.
125. Any one preceding embodiment, wherein Component B comprises 1,4-butane diol.

### EXAMPLES

TABLE 1
List of ingredients used in the Examples

| Trademark or | |
|---|---|
| abbreviation | Chemistry |
| Voranol ™ | a capped polyether triol |
| CP4610 | Average equivalent weight 1602.8 g/eq |
| | Molecular weight 4808 g/mol |
| | Hydroxyl number: 33-37 KOH/g, according to ASTM |
| | D4274-94d |
| ISONATE | Low viscosity, modified diphenylmethane diisocyanate |
| M143 | containing a high percentage or pure diphenylmethane |
| | diisocyanate, and a lesser amount of polycarbodiimide |
| | adducts, having an isocyanate functionality of about |
| | 2.2, and a molecular weight of 315 Da. |
| Voronate | low viscosity polymethylene polyphenylisocyanate of |
| M220 | high reactivity, a total isocyante content of about 31% |
| | and an average functionality of 2.7 |
| | TDS says: “a low viscosity mixture of diphenyl- |
| | methane-4,4′-diisocyanate with isomers and |
| | homologues of higer functionality |
| | SDS says: “Diphenylmethane Diisocyanate, isomers |
| | and homologues” |
| 1,4 butanediol | 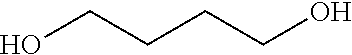 |
| Fomrez UL29 | dioctyltin mercaptide catalyst |
| Fomrez UL38 | Dioctyltin dinedecanoate |
| Fomrez UL54 | Dimethyltin dithioglycolate |
| Polycat | an acid-free heat activated delayed action polyurethane |
| SA 1/10 | catalyst that provides excellent back-end cure |
| Apyral 1E | Aluminum trihydroxide (ATH) having the following |
| (50 □m) | particle size distribution: |
| | D₁₀ 10 μm |
| | D₅₀ 50 μm |
| | D₉₀ 100 μm |
| Apyral 44 | Aluminum trihydroxide (ATH) having the following |
| (6 □m) | particle size distribution: |
| | D₅₀ 8 μm |
| | D₉₀ 19 μm |
| ES 100 C10 | Expandable graphite |
| | Carbon content: mon. 92%, expansion in cm³/g: 100, |
| | particle size: 75% <150 μm |
| ES 250 B5 | Expandable graphite |
| | Carbon content: min. 90%, expansion in cm³/g: 250, |
| | particle size: 80% >300 μm |
| Timrex | Graphite with aspect ratio >2, D₉₀: 90 μm: BET |
| C-thermo11 | 25 m²/g |
| Timrex KS44 | Spherical graphite with D₅₀ of 15.8 μm; D90: 45 μm |
| | BET 9 m²/g |
| Silquest A187 | gamma-Glycidoxypropyltrimethoxysilane |
| graphene | Graphene nanoplatelets, aspect ratio >2 |
| xGnP-R25 | Surface area: 30-60 m²/g |
| | Thickness: 16-20 nm |
| | Density: 2.2 g/cm³ |
| | Average platelet size: 25 μm |
| molecular | Alkali alumina silicate, zeolite, molecular sieve |
| sieve 4st | Particle size, points/scratches: 24/20 μm (EN ISO |
| | 1524/ASTM D 1210 |
| DESMODUR | Aromatic polyisocyanate prepolymer based on |
| 22 | diphenylmethane diisocyanate, equivalent weight |
| | 472-506 g/eq |
| Voranol ™ | Polypropylene glycol homopolymer diol. |
| 1010L | Average equivalent weight: 512.3 g/eq |
| | Average OH number: 109 KOH/g |
| | Molecular weight: 1024 g/mol |
| | Nominal functionality: 2 |
| Vorapel ™ | A low viscosity, hydrophobic (polybutyleneoxide) |
| D3201 | diol, with: |
| | Average equivalent weight: 1001.7 g/eq |
| | Average OH number: 56 KOH/g |
| | Molecular weight: 2003 g/mol |
| | Nominal functionality: 2 |
| Voranol ™ | a polypropylene glycol homopolymer diol. |
| P400 | Average equivalent weight: 215.7 g/eq |
| | Average OH number: 260 KOH/g |
| | Molecular weight: 431 g/mol |
| | Nominal functionality: 2 |
| Polyvest HT | Polybutadiene diol of MWT approximately 2,900 Da, |
| | mean OH functionality of 2.4 |
| Aluminum | Aluminum powder with D₅₀ of 45 μm |
| powder | |

### Formulation of Adhesives

Component A (isocyanate) and Component B (polyol) were prepared in a 4-5 L planetary mixer laboratory scale mixer. Using the ingredients listed in Table 2.

To prepare Component B (polyol), an OH-terminated prepolymer was prepared by first mixing the polyol ingredients of Component B, listed in Table 2. The isocyanate ingredients were then added and the mixture was mixed under vacuum and at a temperature of 35° C. in a planetary mixer. The filler ingredients were then added and mixed under 80 mbar vacuum for 45 minutes. The vacuum was broken under nitrogen, and Component B was filled in cartridges until use.

To prepare Component A (isocyanate), an isocyanate-terminated prepolymer was prepared by first mixing the polyol ingredients of Component A (diols and/or triols). The isocyanate ingredients were then added with stirring room temperature. The filler ingredients were then added and the mixture was heated to 70° C. and stirred under 80 mbar vacuum for 60 minutes. The material is actively cooled down to temperature lower than 30° C. The vacuum was broken under nitrogen, and Component A was filled and stored in cartridges until use.

Components A and B were stored separately until use. Immediately before use, the components were mixed in a 1:1 volumetric ratio. The resulting adhesive was cured for seven days at 23° C. and the properties were measured.

### Test Methods

### Thermal Conductivity

Thermal conductivity: Thermal conductivity was measured according to ASTM 5470. A thermal interface material tester from ZFW Stuttgart was used for the test. The upper contact was heated to cca 40° C. and the lower contact to cca 10° C., resulting in a sample temperature gradient of ca 25° C. The tests were performed on cured material (7 days, 23° C., 50% RH), 2 mm thickness. In order to ensure a better contact between the tested material, the upper and lower heated contact a thermal conductive oil, KRYO 30 from Lauda was add on the surface of the cured material and pressure up till 10 bars was applied on between the thermal contacts. The absolute thermal conductivity λeff (W/mK) is reported.

### Elongation at Break

Elongation at break was measured according to ISO EN 572-2.

### Lap Shear Strength

Lap shear strength was measured according to DIN EN1465. The samples were e-coated steel, having dimensions of 100×25×1.6, and adhesion area of 15 mm and an adhesive thickness of 1 mm. The adhesive was cured for seven days at 23° C. Lap shear strength was also evaluated after exposure for seven days at 70° C. and 100% relative humidity (RH).

### Dielectric Strength

Dielectric strength was measured according to IEC 60243/ASTM D 149-97A using samples of the adhesives obtained by mixing Component A and Component B in a 1:1 volumetric ratio, and allowing the adhesive to cure for 7 days at 23° C. and 50% relative humidity.

### Volume Resistivity

Volume resistivity was measured according to DIN IEC 60093 using samples of the adhesives obtained by mixing Component A and Component B in a 1:1 volumetric ratio, and allowing the adhesive to cure for 7 days at 23° C. and 50% relative humidity.

TABLE 2
Ingredients in Inventive Examples (IE) and Comparative Examples
(CE) in wt %, as well as properties of the cured adhesives

| Ingredient | CE1 | CE2 | CE3 | IE1 | IE2 |
|---|---|---|---|---|---|
| Component B (polyol) (wt %) | | | | | |
| VORANOL CP4610 | 29.99 | 21.63 | 31.79 | 33.158 | 33.158 |
| ISONATE M143 | 2.5 | 1.00 | 1.44 | 1.50 | 1.50 |
| 1,4-butane diol | 6 | 4.00 | 5.73 | 6.0 | 6.0 |
| Apyral 1E | 43 | 60.34 | 40.5 | 40.5 | 40.5 |
| Apyral 44 | 9 | 12.42 | 6 | 6 | 6 |
| ES 100 C10 | 3.75 | — | — | — | — |
| ES 250 B5E | 3 | — | — | — | — |
| Timrex C-Thermo-011 | — | — | — | — | 1.3 |
| Timrex KS44 | — | — | 13 | 10 | 10 |
| Graphene xGnP-R25 | 1.2 | — | — | 1.3 | — |
| POLYCAT SA 1/10 | 0.05 | 0.10 | — | — | — |
| Fomrez UL29 | 0.015 | 0.02 | 0.025 | 0.04 | 0.04 |
| Fomrez UL38 | — | — | 0.01 | — | — |
| Fomrez UL54 | — | — | — | 0.002 | 0.002 |
| Molecular sieve 4ST | 1 | — | 1 | 1 | 1 |
| Silquest A187 | 0.5 | 0.5 | 0.5 | 0.5 | 0.5 |
| % vol filler | 39.83 | 53.13 | 38.73 | 37.32 | 37.32 |
| % vol ATH | 84.83 | 100.00 | 78.15 | 79.60 | 79.60 |
| Component A (isocyanate) (wt %) | | | | | |
| VORANOL 1010L | 8.25 | 9.00 | 8.68 | 9.15 | 9.15 |
| VORANOL P400 | 3.65 | — | 3.84 | 4.08 | 4.08 |
| ISONATE M143 | 27.80 | — | 28.78 | 30.40 | 30.40 |
| VORONATE M220 | 4.56 | — | 0.60 | 0.63 | 0.63 |
| DESMODUR 22 | — | 17.00 | — | — | — |
| Apyral 1E | 43.60 | 61.00 | 33.60 | 43.60 | 43.60 |
| Apyral 44 | 5.00 | 13.00 | 5.00 | 5.00 | 5.00 |
| ES 100 C10 | 4.00 | — | — | — | — |
| ES 250 B5E | 1.44 | — | — | — | — |
| Timrex C-Thermo-011 | — | — | — | — | 1.20 |
| Timrex KS44 | — | — | 9.00 | 5.44 | 5.44 |
| Graphene xGnP-R25 | 1.20 | — | — | 1.20 | — |
| Aluminium powder | — | — | 10.00 | — | — |
| Silquest A187 | 0.5 | — | 0.5 | 0.5 | 0.5 |
| % vol filler | 37.47 | 57.1 | 38.59 | 36.81 | 36.81 |
| % vol ATH | 36.28 | 100 | 68.33 | 87.94 | 87.94 |
| DATA | | | | | |
| Thermal conductivity (W/mK) | 1.00 | 1.35 | 1.03 | 1.35 | 1.35 |
| Working time (s) | 360 | 45 | 330 | 210 | 210 |
| Lap shear strength after 45 min., | 0.01 | — | 0.46 | 0.40 | 0.40 |
| 23° C., 50% relative humidity | | | | | |
| Lap shear strength after 7 days, | 5.0/100% | — | 5.6 | 5.1 | 5.6 |
| 23° C., 50% relative humidity/ | CF | | | | |
| failure mode | | | | | |
| Tensile strength, 7 MPa | 9.1 | 12.4 | 8.9 | 9.8 | 11.1 |
| E-modulus (Mpa) | 315 | 774 | 173 | 103 | 110.8 |
| Elongation at break (%) | 15 | 6 | 15 | 23 | 38 |
| Dielectric strength (KV/mm) | 0.6 | — | — | — | 3.7 |
| Volume resistivity (Ωcm) | 5 × 10¹³ | — | — | — | 7 × 10¹² |
| Flame rating UL94 | V0 | — | — | — | V1 |

1. A two-component, thermally-conductive polyurethane adhesive comprising:
A. a first component (isocyanate) comprising an NCO-terminated prepolymer made by reacting at least one polyol with at least one polyisocyanate;
B. a second component (polyol) comprising an OH-terminated prepolymer made by reacting at least one polyol with at least one polyisocyanate, and a catalyst capable of catalyzing the reaction of isocyanate groups with OH groups;
wherein Component A and/or Component B comprise the following fillers:
aluminium trihydroxide having a multimodal (preferably bimodal) particle size distribution;
graphite having a spherical particle shape; and
graphite having an aspect ratio greater than 2;
such that when Component A and Component B are mixed together to form an adhesive mixture, the adhesive mixture comprises more than 40 wt % aluminium trihydroxide and more than 8 wt % graphite.

2. The adhesive of claim 1, wherein the at least one polyol used to make the NCO-terminated prepolymer is a polyether polyol.

3. The adhesive of claim 1, wherein the at least one polyol used to make the NCO-terminated prepolymer is selected from polyols with functionality ≥2.

4. The adhesive of claim 1, wherein the at least one polyol used to make the NCO-terminated prepolymer has a functionality of 2.

5. The adhesive of claim 1, wherein the polyol used to make the NCO-terminated prepolymer is selected from poly(C₂-C₄-alkylene oxide) polyols, in particular poly(ethylene oxide) polyols, poly(propylene oxide) polyols, poly(tetramethylene oxide) polyols, and mixtures of these.

6. The adhesive of claim 1, wherein the polyol used to make the NCO-terminated prepolymer a poly(propylene oxide) polyol.

7. The adhesive of claim 1, wherein the polyol used to make the NCO-terminated prepolymer is selected from poly(propylene oxide) polyols having a functionality of 2-3.

8. The adhesive of claim 1, wherein the at least one polyol used to make the NCO-terminated prepolymer has a molecular weight of from 400-2,500 Da.

9. The adhesive of claim 1, wherein the at least one polyol used to make the NCO-terminated prepolymer preferably has an average equivalent weight of 200-1,250 g/eq.

10. The adhesive of claim 1, wherein the at least one polyol used to make the NCO-terminated prepolymer is a mixture of polyols.

11. The adhesive of claim 1, wherein the at least one polyol used to make the NCO-terminated prepolymer is a mixture of polyols comprising a polyol having an average equivalent weight from 200-250 g/eq and a polyol having an average equivalent weight from 475-550 g/eq.

12. The adhesive of claim 1, wherein the at least one polyol used to make the NCO-terminated prepolymer is a mixture of a poly(propylene oxide)-based polyol having an average equivalent weight from 200-250 g/eq and a poly(propylene oxide)-based polyol having an average equivalent weight from 475-550 g/eq.

13. The adhesive of claim 1, wherein the at least one polyol used to make the NCO-terminated prepolymer is a mixture of a poly(propylene oxide)-based diol having an average equivalent weight from 200-250 g/eq and a poly(propylene oxide)-based diol having an average equivalent weight from 475-550 g/eq.

14. The adhesive of claim 1, wherein the at least one polyol used to make the NCO-terminated prepolymer comprises a poly(propylene oxide)-based polyol having an average equivalent weight from 200-250 g/eq (P1) and a poly(propylene oxide)-based polyol having an average equivalent weight from 475-550 g/eq (P2), wherein the ratio of P1:P2 is 0.35-0.55.

15. The adhesive of claim 1, wherein the at least one polyol used to make the NCO-terminated prepolymer is a mixture of a poly(propylene oxide)-based diol having an average equivalent weight from 200-250 g/eq (P1) and a poly(propylene oxide)-based diol having an average equivalent weight from 475-550 g/eq (P2), wherein the ratio of P1:P2 is 0.35-0.55.
